(19) United States
(12) Patent Application Publication
(10) Pub. No.: US 2026/0330806 A1
(43) Pub. Date: Oct. 22, 2026

(54) COIN IDENTIFICATION METHOD AND SYSTEM, AND STORAGE MEDIUM

(71) Applicant: Hangzhou Ruisheng Software Co., Ltd., Zhejiang (CN)

(72) Inventors: Qingsong Xu, Zhejiang (CN); Qing Li, Zhejiang (CN)

(73) Assignee: Hangzhou Ruisheng Software Co., Ltd., Zhejiang (CN)

(21) Appl. No.: 19/109,564

(22) PCT Filed: Aug. 8, 2023
(86) PCT No.: PCT/CN2023/111654

§ 371 Date: Mar. 7, 2025

(30) Foreign Application Priority Data
Sep. 9, 2022 (CN) 202211104660.5

(51) Int. Cl. G06V 10/764; G06V 10/26; G06V 10/30; G06V 10/74

(52) U.S. Cl. CPC G06V 10/764; G06V 10/273; G06V 10/30; G06V 10/761

(57) ABSTRACT

Provided in the present disclosure are a coin identification method and system, and a storage medium. The method comprises: acquiring a coin picture, which is provided by a user; identifying the coin picture to acquire a coin region, and performing segmentation to acquire coin region pictures; identifying the coin region pictures to acquire a plurality of feature regions; identifying the plurality of feature regions to acquire a plurality of coin feature information; and synthesizing the plurality of coin feature information to acquire classification information of a coin. The coin identification method provided in the present disclosure can improve the accuracy of coin identification.

### TECHNICAL FIELD

The present disclosure relates to the field of computer technology, particularly to a coin identification method and system, and a storage medium.

### DESCRIPTION OF RELATED ART

Coins may be categorized into various types, including currency coins and commemorative coins. There is a discernible demand for the identification of both circulating currency and collectible or commemorative coins. However, due to reasons such as some coins circulating less or being naturally rare, there is a scarcity of samples. Furthermore, the unique material properties of coins, variations in texture between new and old specimens, issues with light reflection, unpredictable user photography environments, and complex backgrounds contribute to diverse characteristics even among identical coins. Consequently, user-captured coin pictures may differ significantly from standard coin pictures. Additionally, different coin denominations may have similar shapes, with key distinguishing features being texture and textual elements. As a result, picture quality significantly impacts identification accuracy, with even slight blurring potentially leading to a complete loss of critical information. Moreover, the existence of various scenarios, such as distant photography or low-resolution pictures, further complicates the matter. These factors collectively render coin identification technically challenging, resulting in suboptimal accuracy rates in existing coin identification systems.

### SUMMARY OF THE DISCLOSURE

A purpose of this disclosure is to provide a coin identification method, including:
acquiring a coin picture provided by a user;
identifying the coin picture to acquire a coin region, and performing segmentation to acquire a coin region picture;
identifying the coin region picture to acquire a plurality of feature regions;
identifying the plurality of feature regions to acquire a plurality of coin feature information;
synthesizing the plurality of coin feature information to acquire classification information of the coin.

In some embodiments, identifying the coin picture to acquire the coin region comprises: processing the coin picture by using a UNet-based image segmentation to acquire the coin region.

In some embodiments, identifying the coin picture to acquire the coin region, and performing segmentation to acquire a coin region picture includes:
identifying the coin region according to a region detection model to acquire a coin mask region, and performing segmentation to acquire the coin region picture.

In some embodiments, the method further includes: performing ellipse detection and circular correction on the coin region picture.

In some embodiments, the method further includes: performing image preprocessing on the coin region picture acquired by segmentation to acquire a coin region picture with background and noise removed;
wherein identifying the coin region picture to acquire the plurality of feature regions includes: identifying a preprocessed coin region picture to acquire the plurality of feature regions.

In some embodiments, the method further includes: performing image preprocessing on the coin picture provided by the user to acquire a coin picture with background and noise removed;
wherein identifying the coin picture to acquire the coin region, and performing segmentation to acquire a coin region picture includes: identifying a preprocessed coin picture to acquire the coin region, and performing segmentation to acquire the coin region picture.

In some embodiments, after performing segmentation to acquire the coin region picture, the method further includes: performing post-processing on the coin region picture using a CV algorithm to remove redundant noise points.

In some embodiments, acquiring the coin picture provided by the user includes: providing at least two windows for user selection on an interactive interface, allowing the user to select and provide pictures of different sides of a current coin to be identified.

In some embodiments, it is determined whether the coin picture provided by the user belongs to an obverse side or a reverse side according to a pre-trained obverse-reverse identification model.

In some embodiments, identifying the coin region picture to acquire the plurality of feature regions includes: identifying the coin region picture according to a pre-trained feature region identification model to acquire the plurality of feature regions.

In some embodiments, a self-supervised pre-trained backbone model based on contrastive learning is adopted to identify the plurality of feature regions respectively to acquire the plurality of coin feature information.

In some embodiments, synthesizing the plurality of coin feature information to acquire the classification information of the coin includes: adopting a similarity comparison method to acquire a comprehensive similarity of the coin, and sorting the classification information of the coin according to the comprehensive similarity.

According to another aspect of this disclosure, a coin identification system is provided, including a processor and a memory, wherein the memory stores a program, and when the program is executed by the processor, the coin identification method as described above is implemented.

According to another aspect of this disclosure, a storage medium is provided, which stores a program, and when the program is executed, the coin identification method as described above is implemented.

Through the following detailed description of exemplary embodiments of this disclosure with reference to the accompanying drawings, other features and advantages of this disclosure may become clearer.

### BRIEF DESCRIPTION OF THE DRAWINGS

The accompanying drawings, which form a part of this specification, illustrate embodiments of this disclosure and, together with the specification, serve to explain the principles of this disclosure.

With reference to the accompanying drawings, this disclosure may be more comprehensible according to the following detailed description, wherein:

FIG. 1 shows a flow diagram of a coin identification method provided by an embodiment of the present disclosure.

FIG. 2 shows a structural diagram of a coin identification system provided by an embodiment of the present disclosure.

Note that in the following description of the embodiments, the same reference numerals are sometimes used in different drawings to indicate the same parts or parts with the same function, and repeated descriptions of the same reference numerals are omitted. In some cases, similar numerals and letters are used to indicate similar items, so once an item is defined in one drawing, it does not need to be further discussed in subsequent drawings.

For ease of understanding, the positions, dimensions, and ranges of various structures shown in the drawings and the like sometimes do not represent actual positions, dimensions, and ranges. Therefore, this disclosure is not limited to the positions, dimensions, and ranges disclosed in the drawings and the like.

### DESCRIPTION OF THE EMBODIMENTS

The various exemplary embodiments of this disclosure will be described in detail below with reference to the accompanying drawings. It should be noted that: unless otherwise specifically stated, the relative arrangement, numerical expressions, and numerical values of the components and steps described in these embodiments do not limit the scope of this disclosure.

The following description of at least one exemplary embodiment is actually only illustrative and by no means a limitation on this disclosure and its application or use. That is to say, the structures and methods in this document are shown in an exemplary manner to illustrate different embodiments of the structures and methods in this disclosure. However, those skilled in the art will understand that they merely illustrate exemplary ways that may be used to implement this disclosure, rather than exhaustive ways. Furthermore, the drawings need not be drawn to scale, and some features may be enlarged to show details of specific components.

For technologies, methods, and devices already known to ordinary skilled persons in the related field, detailed discussions may not be provided, but in appropriate circumstances, said technologies, methods, and devices should be considered as part of the authorized specification.

In all examples shown and discussed here, any specific values should be interpreted as merely exemplary and not as limitations. Therefore, other examples of exemplary embodiments may have different values.

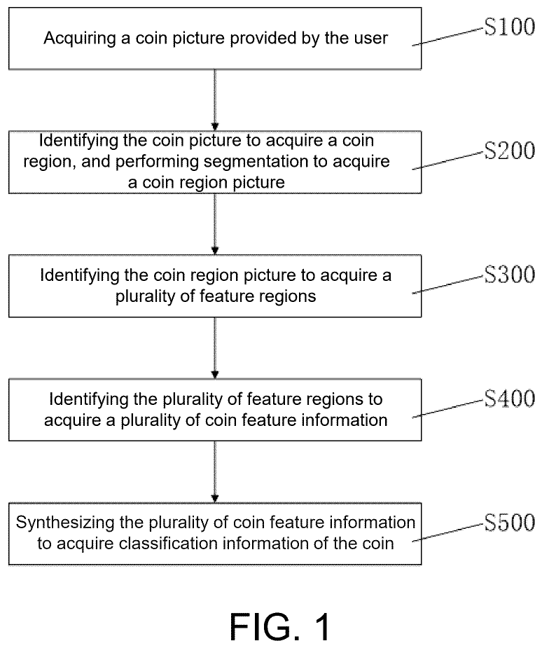

FIG. 1 shows a flow diagram of a coin identification method provided by an embodiment of the present disclosure. This method may be implemented in an application program (app) installed on smart terminals such as mobile phones, tablet computers, etc. As shown in FIG. 1, this method includes:
Step S100: acquiring a coin picture provided by the user;
Step S200: identifying the coin picture to acquire a coin region, and performing segmentation to acquire a coin region picture;
Step S300: identifying the coin region picture to acquire a plurality of feature regions;
Step S400: identifying the plurality of feature regions to acquire a plurality of coin feature information;
Step S500: synthesizing the plurality of coin feature information to acquire classification information of the coin.

In some embodiments, identifying the coin picture to acquire the coin region includes: processing the coin picture by using a UNet-based image segmentation to acquire the coin region. The UNet-based image segmentation adopts a pre-trained neural network model, which may perform identification on the coin picture to acquire the coin region, perform foreground segmentation on the coin picture to obtain the coin region. In addition, other image segmentation processing methods may be adopted, and this disclosure does not impose restrictions in this regard.

In some embodiments, identifying the coin picture to acquire a coin region, and performing segmentation to acquire a coin region picture includes the following.

The coin region is identified according to a region detection model to acquire a coin mask region, and the coin region picture is acquired by performing segmentation. The coin region, which is acquired by processing of the UNet-based image segmentation, may be adopted to directly crop the coin region to acquire the coin region picture. Alternatively, the coin region may be further identified according to a pre-trained coin region detection model to acquire a more precise coin region, and then the coin region picture is acquired by cropping.

In some embodiments, the method further includes: performing ellipse detection and circular correction on the coin region picture. In actual processing, ellipse detection is performed on the coin region picture to acquire the equation of the ellipse, then the pixel mapping parameters for restoring to a circle are calculated based on the ellipse equation. Affine transformation and interpolation processing are performed to convert the coin ellipse in the user's coin picture into a circular shape, the circular correction processing is completed. This facilitates subsequent feature identification processing and corresponding content identification.

In some embodiments, the method further includes: performing image preprocessing on the segmented coin region picture to acquire a coin region picture with background and noise removed, and then identifying the preprocessed coin region picture to acquire a plurality of feature regions. The segmented coin region picture is processed into a clean picture without background and noise, minimizing interference from redundant information. For example, other background factors in the non-foreground coin region to be identified, such as tables or other coins existing in the background of the coin picture, might cause some interference with identification. Removing such background interference factors may accurately acquire the coin region picture to be identified, facilitating subsequent identification of feature regions in the coin region picture without identifying background regions that might cause interference.

In some embodiments, the method further includes: performing image preprocessing on the coin picture provided by the user to acquire a coin picture with background and noise removed, and then identifying the preprocessed coin picture to acquire the coin region, and performing segmentation to acquire the coin region picture. In this embodiment, the preprocessing step is advanced to follow the step of acquiring the coin picture provided by the user, thereby directly preprocessing the user's coin picture to process the coin picture into a clean picture without background and noise, in order to minimize interference from redundant information as much as possible. Then, according to a pre-trained region identification model (such as YOLO and other models), the preprocessed coin picture is identified to acquire the coin region, and segmentation is performed is acquire the coin region picture. Advancing the preprocessing step also eliminates interference from background factors and improves the accuracy of identification.

In some embodiments, after performing segmentation to acquire the coin region picture, post-processing is performed on the coin region picture using a CV algorithm to remove redundant noise points. Performing segmentation to acquire the coin region picture may involve interfering factors such as redundant picture blocks. The edge of the coin region may be obtained through edge detection models or algorithms, such as the Hough circle detection algorithm or pre-trained coin edge detection models to acquire the circular edge of the coin. Morphological processing methods may also be used to assist in removing excess noise interference in the coin region to acquire a more stable coin mask region. Meanwhile, coin pictures with more interfering factors may be used as supplementary samples to retrain the model, facilitating the acquisition of a more accurate identification model for identifying coin regions.

In some embodiments, acquiring the coin picture provided by the user includes: providing at least two windows for the user to select in the interactive interface, allowing the user to select and provide pictures of different sides of the current coin to be identified. Guiding the user to provide pictures of both sides of the coin in the user interface may facilitate obtaining more coin features, making subsequent identification processing more accurate. In addition, identification may also be performed when the user provides the picture with only one side of the coin or a plurality of identical or different pictures. The present disclosure does not impose restrictions in this regard.

In some embodiments, it is determined whether the coin picture provided by the user belongs to the obverse side or reverse side according to a pre-trained obverse-reverse identification model. The classification of obverse and reverse sides of the coin is realized through a picture binary classification method, and a coin obverse and reverse classification identification model is obtained through a pre-established sample training model. By identifying and determining the obverse and reverse classification of the coin picture provided by the user, the coin feature regions on the picture may be more accurately classified and identified, thus improving the accuracy of coin identification.

In some embodiments, identifying the coin region picture to acquire the plurality of feature regions includes: identifying the coin region picture according to a pre-trained feature region identification model to acquire the plurality of feature regions. Different coins have similar basic picture structures that may be roughly classified, such as obverse portraits or patterns, reverse patterns, years, text (letters or numbers), etc., which may be decomposed and classified. Due to various problems described in the background technology, the overall identification accuracy of existing coin technology is relatively low. By decomposing coin features into a plurality of pre-classified feature regions for separate identification and synthesizing to acquire classification information of the coin may significantly improve the accuracy of coin identification. The pre-trained feature region identification model conducts region identification and detection on the key common regions of coins, processes them by cropping, and processes the overall features of coins into a plurality of different feature regions, facilitating subsequent feature identification.

In some embodiments, in the step of identifying the plurality of feature regions separately to acquire the plurality of coin feature information, a self-supervised pre-trained backbone model based on contrastive learning is adopted. By obtaining a plurality of different feature regions of the coin, feature extraction is performed respectively, and then identification or retrieval is performed to obtain corresponding feature identification information. The distinctive features between coins lie in textures, text, etc. General pre-trained models perform poorly, with the core difficulty being the small number of training pictures. However, by conducting pre-training through self-supervision based on contrastive learning, performing similarity comparison, and obtaining the corresponding self-supervised pre-trained backbone model based on contrastive learning, the identification accuracy may be significantly improved. The self-supervised pre-trained backbone model based on contrastive learning is fine-tuned and regression tested, and parameters and test sample sets are adjusted to obtain a backbone model with high identification accuracy.

In some embodiments, synthesizing the plurality of coin feature information to acquire the classification information of the coin includes adopting a similarity comparison method. According to the feature information of the plurality of different feature regions recognized on the coin, and comparison is performed by comparing with standard feature information to acquire the similarity, then the different similarities of the plurality of feature regions are synthesized to obtain the comprehensive similarity of the coin, and the classification information of the coin is sorted according to the comprehensive similarity. One or more coin identification results with the highest similarity match may be output and displayed to the user, or all coin classification information may be output and displayed to the user in order of similarity for the user to browse and select. The similarity between various feature regions and standard feature information may be obtained by retrieving from a preset standard feature information database or using a pre-trained model identification method. Calculating the comprehensive similarity of the coin may also be processed by setting different weights according to the information of different feature regions.

In some embodiments, according to the self-supervised pre-trained backbone model based on contrastive learning, the identification result and the confidence (confidence refers to the credibility of the current identification result obtained by the model identification) of each feature region in the a plurality of feature regions are obtained separately, thereby synthesizing the overall confidence of the identification result of the coin to be identified. Meanwhile, combining with the comprehensive similarity of the coin to be identified that has been obtained as above, the overall confidence and comprehensive similarity are weighted and calculated to obtain the possibility score of the current identification result of the coin to be identified. Finally, the coin identification results are sorted and output for display according to the possibility score. Calculating the overall confidence of the coin may also be processed by setting different weights according to the information of different feature regions.

In some embodiments, after the above coin identification results are sorted according to similarity or possibility score, the year identification result of the coin to be identified is obtained. The identification results are filtered according to the closest coin year number and then output. For example, when the same coin identification result has a plurality of year versions, the identification result of the version with the same year or the closest year to the current coin to be identified is filtered and output for display.

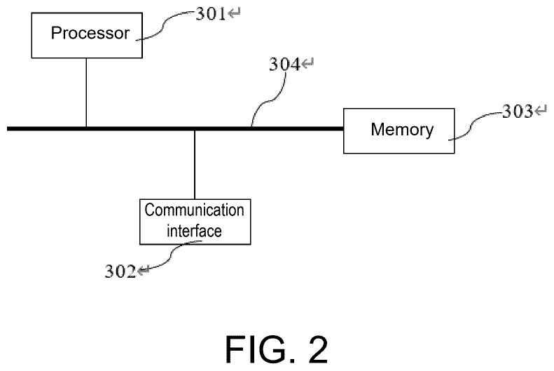

Based on the same inventive concept, the present disclosure further provides a coin identification system, including a processor and a memory, where the memory stores a program, and when the program is executed by the processor, the coin identification method as described above is implemented. Please refer to FIG. 2, FIG. 2 shows a structural diagram of a coin identification system provided by an embodiment of the present disclosure. As shown in FIG. 2, the coin identification system includes a processor 301, a communication interface 302, a memory 303, and a communication bus 304.

The processor 301, the communication interface 302, and the memory 303 complete communication with each other through the communication bus 304.

The memory 303 is configured to store computer programs.

The processor 301 is configured to execute the program stored in the memory 303 to implement the following steps:
acquiring a coin picture provided by a user;
identifying the coin picture to acquire a coin region, and performing segmentation to acquire a coin region picture;
identifying the coin region picture to acquire a plurality of feature regions;
identifying the plurality of feature regions to acquire a plurality of coin feature information;
synthesizing the plurality of coin feature information to acquire classification information of the coin.

Regarding the specific embodiment of each step of this method and related explanatory content, reference may be made to the implementation of the method shown in FIG. 1 above, which will not be repeated here.

In addition, other embodiments of the coin identification method implemented by the processor 301 executing the program stored in the memory 303 are the same as the embodiments mentioned in the previous embodiments of the method, which will not be repeated here.

The communication bus 304 mentioned in the above electronic device may be a Peripheral Component Interconnect (PCI) bus or an Extended Industry Standard Architecture (EISA) bus, etc. This communication bus 304 may be divided into address bus, data bus, control bus, etc. For convenience of illustration, only one thick line is used in the figure, but this does not indicate that there is only one bus or one type of bus.

The communication interface 302 is provided for communication between the above-mentioned electronic device and other devices.

The processor 301 may be a Central Processing Unit (CPU), and may also be other general-purpose processors, Digital Signal Processors (DSP), Application Specific Integrated Circuits (ASIC), Field-Programmable Gate Arrays (FPGA) or other programmable logic devices, discrete gates or transistor logic devices, discrete hardware components, etc. The general-purpose processor may be a microprocessor or the processor may also be any conventional processor, etc. The processor 301 is the control center of the electronic device, connecting various parts of the entire electronic device through various interfaces and lines.

The memory 303 may be configured to store the computer program, and the processor 301 may realize various functions of the electronic device by running or executing the computer program stored in the memory 303, as well as invoking the data stored in the memory 303.

The memory 303 may include non-volatile and/or volatile memory. Non-volatile memory may include Read-Only Memory (ROM), Programmable ROM (PROM), Electrically Programmable ROM (EPROM), Electrically Erasable Programmable ROM (EEPROM) or flash memory. Volatile memory may include Random Access Memory (RAM) or external high-speed cache memory. As an illustration rather than a limitation, RAM is available in many forms, such as Static RAM (SRAM), Dynamic RAM (DRAM), Synchronous DRAM (SDRAM), Double Data Rate SDRAM (DDRSDRAM), Enhanced SDRAM (ESDRAM), Synchlink DRAM (SLDRAM), Rambus Direct RAM (RDRAM), Direct Rambus Dynamic RAM (DRDRAM), and Rambus Dynamic RAM (RDRAM), etc.

According to another aspect of this disclosure, the present disclosure further provides a storage medium, which stores a program, and when the program is executed, the following steps are implemented:
acquiring a coin picture provided by a user;
identifying the coin picture to acquire a coin region, and performing segmentation to acquire a coin region picture;
identifying the coin region picture to acquire a plurality of feature regions;
identifying the plurality of feature regions to acquire a plurality of coin feature information;
synthesizing the plurality of coin feature information to acquire classification information of the coin.

The computer-readable storage medium in the embodiments of the present disclosure may adopt any combination of one or more computer-readable media. The computer-readable medium may be a computer-readable signal medium or a computer-readable storage medium. The computer-readable storage medium may be, but not limited to, an electric, magnetic, optical, electromagnetic, infrared, or semiconductor system, device or apparatus, or any combination thereof. More specific examples of the computer-readable storage medium (non-exhaustive list) include: an electrical connection having one or more wires, a portable computer hard disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the text, a computer-readable storage medium may be any tangible medium that contains or stores a program, which may be used by or in combination with an instruction execution system, apparatus, or device.

The computer-readable signal medium may include a data signal propagating in a baseband or as part of a carrier wave, which carries computer-readable program code. This propagated data signal may take various forms, including but not limited to electromagnetic signals, optical signals, or any suitable combination thereof. The computer-readable signal medium may also be any computer-readable medium other than the computer-readable storage medium, which is able to send, propagate, or transmit a program for use by or in combination with an instruction execution system, apparatus, or device.

The computer program code for performing the operations of the present disclosure may be written in one or more programming languages or a combination thereof, including object-oriented programming languages such as Java, Smalltalk, C++, as well as conventional procedural programming languages such as “C” language or similar programming languages. The program code may execute entirely on the user's computer, partly on the user's computer, as a stand-alone software package, partly on the user's computer and partly on a remote computer, or entirely on a remote computer or server. In the case involving a remote computer, the remote computer may be connected to the user's computer through any type of network, including a local region network (LAN) or a wide region network (WAN), or may be connected to an external computer (for example, through the Internet using an Internet Service Provider).

It should be noted that the device and method disclosed in the embodiments of the text may also be implemented in other ways. The described embodiments of the device are merely illustrative. For example, the flowcharts and block diagrams in the drawings show possible embodiments of the architecture, functions, and operations of devices, methods, and computer program products according to a plurality of embodiments of the text. In this regard, each block in the flowchart or block diagram may represent a module, program segment, or part of code, which contains one or more executable instructions for implementing the specified logical function(s). It should also be noted that, in some alternative embodiments, the functions noted in the blocks may occur in a different order than that noted in the figures. For example, two consecutive blocks may in fact be executed substantially in parallel, they may sometimes be executed in the reverse order, depending on the functionality involved. It should also be noted that each block of the block diagrams and/or flowchart, and combinations of blocks in the block diagrams and/or flowchart, may be implemented by special-purpose hardware-based systems that perform the specified functions or acts, or combinations of special-purpose hardware and computer instructions.

Additionally, the various functional modules in various embodiments of the present disclosure may be integrated together to form an independent part, or they may exist separately as individual modules, or two or more modules may be integrated to form an independent part.

The above description is only a description of the preferred embodiments of the present disclosure and does not limit the scope of the present disclosure in any way. Any changes or modifications made by ordinary skilled persons in the art of the present disclosure based on the above disclosure are within the scope to be protected by the claims.

1. A coin identification method, characterized in comprising:
acquiring a coin picture provided by a user;
identifying the coin picture to acquire a coin region, and performing segmentation to acquire a coin region picture;
identifying the coin region picture to acquire a plurality of feature regions;
identifying the plurality of feature regions to acquire a plurality of coin feature information;
synthesizing the plurality of coin feature information to acquire classification information of a coin.

2. The coin identification method according to claim 1, wherein identifying the coin picture to acquire the coin region comprises: processing the coin picture by using a UNet-based image segmentation to acquire the coin region.

3. The coin identification method according to claim 1, wherein identifying the coin picture to acquire the coin region, and performing segmentation to acquire the coin region picture comprises:
identifying the coin region according to a region detection model to acquire a coin mask region, and performing segmentation to acquire the coin region picture.

4. The coin identification method according to claim 1, wherein the method further comprises: performing ellipse detection and circular correction on the coin region picture.

5. The coin identification method according to claim 1, wherein the method further comprises: performing image preprocessing on the coin region picture acquired by segmentation to acquire a coin region picture with background and noise removed;
wherein identifying the coin region picture to acquire the plurality of feature regions comprises: identifying a preprocessed coin region picture to acquire the plurality of feature regions.

6. The coin identification method according to claim 1, wherein the method further comprises:
performing image preprocessing on the coin picture provided by the user to acquire a coin picture with background and noise removed;
wherein identifying the coin picture to acquire the coin region, and performing segmentation to acquire the coin region picture comprises: identifying a preprocessed coin picture to acquire the coin region, and performing segmentation to acquire the coin region picture.

7. The coin identification method according to claim 1, wherein after performing segmentation to acquire the coin region picture, the method further comprises: performing post-processing on the coin region picture using a CV algorithm to remove redundant noise points.

8. The coin identification method according to claim 1, wherein acquiring the coin picture provided by the user comprises:
providing at least two windows for user selection on an interactive interface, allowing the user to select and provide pictures of different sides of a current coin to be identified.

9. The coin identification method according to claim 8, wherein it is determined whether the coin picture provided by the user belongs to an obverse side or a reverse side according to a pre-trained obverse-reverse identification model.

10. The coin identification method according to claim 1, wherein identifying the coin region picture to acquire the plurality of feature regions comprises: identifying the coin region picture according to a pre-trained feature region identification model to acquire the plurality of feature regions.

11. The coin identification method according to claim 1, wherein a self-supervised pre-trained backbone model based on contrastive learning is adopted to identify the plurality of feature regions respectively to acquire the plurality of coin feature information.

12. The coin identification method according to claim 1, wherein synthesizing the plurality of coin feature information to acquire the classification information of the coin comprises: adopting a similarity comparison method to acquire a comprehensive similarity of the coin, and sorting the classification information of the coin according to the comprehensive similarity.

13. A coin identification system, characterized in comprising a processor and a memory, wherein the memory stores a program, and when the program is executed by the processor, the coin identification method according to claim 1 is implemented.

14. A non-transitory computer readable storage medium, which stores a program, wherein when the program is executed, the coin identification method according to claim 1 is implemented.
